(19) United States
(12) Patent Application Publication
(10) Pub. No.: US 2005/0055726 A1
(43) Pub. Date: Mar. 10, 2005

(54) Communication system for video information, in particular product information

(76) Inventors: Uwe Prochnow, Essen (DE); Rainer Blome, Paderborn (DE)

Correspondence Address: BROWDY AND NEIMARK, P.L.L.C.;624 NINTH STREET, NW, SUITE 300, WASHINGTON, DC, 20001-5303, US

(21) Appl. No.: 10/495,529

(22) PCT Filed: Oct. 31, 2002
(86) PCT No.: PCT/EP02/12127

(30) Foreign Application Priority Data
Nov. 13, 2001 (DE) 101 55 654.3

(51) Int. Cl. H04N 7/173

(52) U.S. Cl. 725/93; 725/92; 725/94

(57) ABSTRACT

The invention relates to a communication system comprising a central station (1), provided with a memory (MEM) and a connection device (COM) to at least one communication network (NET). Said communication system provides video information, in particular digitalized images and films, which are transmitted via said communication network (NET) to each remote station (2), connected to said network. Said video information is optionally buffered into said remote station (2) and displayed on a visual display terminal (VID2). According to said invention, the memory (MEM) of said central station (1) is an electronic memory (MEM), in which several video information blocks (VIDB) are to be memorized, which are recorded in an index (CONT). Said memory transmits one of the selected information blocks (VIDB) to the respective communicating remote station (2) by means of a management program (ADM) depending on the demand and keeps a record thereof in a statistical and/or accounting memory area (AS).

The present invention is concerned with a communication system comprising a central station (1) provided with a memory (MEM) and a connection means (COM) to at least one communication network (NET) for video information, in particular digitized images and films, which are transmitted over the communication network (NET) to given remote stations (2) connected to it and displayed there on a display terminal (VID2).

Communication systems of this type are common in hotels, where video films are maintained centrally and selected films are transmitted on demand to video equipment that is installed in the hotel rooms.

It is furthermore known to arrange video equipment in department stores, hardware stores, etc., on merchandise display racks containing new products, and playing on them videotapes or CDs with related advertising information.

Both systems require expensive logistics to make available and select the data carriers and transport them to the site.

In U.S. Pat. No. 5,661,517, an interactive video service system for hospitality locations is described, which is based on special room terminals and television sets in the rooms. The transmission preferably takes place in analog form over cables, however, provision for a digital transmission is made as well. The video server has one or multiple large memory units from which the video sequences are called up. However, no memory is provided for in the receiver, in which individual digital sequences are stored, which are then played back locally. The room terminals are complex units, which are specially manufactured for the system.

In patent application EP 0 605 115 A2, an interactive video server for a cable TV network is described, which operates with a large central data storage. The calling up of individual sequences is controlled in each case through a special instruction word, which is stored in a separate instruction word memory and processed by an additional specialized pipeline processor. This means that a multi-step special server is required. In this application the remote station (user) is not described in any detail. However, a cable TV network is presumed as the distribution system and the remote stations are normal TV sets.

It is the object of the invention to create a simpler, more efficient communication system that can be used in more different ways.

This object is met in such a way that the memory of the central station is an electronic memory, in which multiple video information blocks are to be stored which, in each case, are registered in an index, and transmits on demand by means of a housekeeping program to the given communicating remote station one of the information blocks, which is stored there intermediately and then played back locally, and the central station keeps a record thereof in a statistics and/or accounting memory area.

Additional advantageous embodiments are specified in the subclaims.

The invention extends both to the novel central station in its design and its functions, as well as to the remote stations, which exist in large numbers, to the extent in which they incorporate novel functions in each case.

The remote station, in cases in which preexisting video equipment is to be used, consists of the controller with the peripheral devices for program selection, etc., and a video output to the playback unit with monitor and loudspeakers.

The central station records the fixed images or image sequences and stores them, preferably in compressed form. The films may be commercials, user instructions, feature films, video games, or the like. The fixed images are, e.g., indexes, movie reviews, etc., which may be designed in the form of menus and presented in preparation for access to additional information.

In the hotel business, presenting advertising information on the video equipment eliminates the need for laying out brochures, restaurant guides, menus, etc. To the extent in which input/output devices are connected to the remote station, such as credit card readers, hotel pass readers, printers, etc., billing processes can be applied directly to the individual guest and receipts can be printed. Image or text pages that are intended for video presentation may also be printed on the printer, especially in the case of brochure information that is meant to be taken away.

If the remote station is to be connected to the central station via an internal or public dial-in network, it can also be used to establish a connection to other subscribers, e.g., to the other remote stations in the various hotel rooms, or to external network terminals. Verbal communication from station to station or to external telephones is thus possible, provided that a voice input is connected such as on the telephone, and an SMS message can be sent or received. Each remote station has its address code and can thus be reached directly, or optionally via an intermediate station along the line of an ISDN extension, or the like.

Decompression of the image data, as well as formatting into the desired video format, such as PAL, NTSC, Secam, preferably takes place at the remote station or optionally at the intermediate station.

Use of the remote stations in department stores has the major advantage that delivery of the merchandise can take place independently from the advertising video film, as the image information can be called up any time, as soon as it is fed in at the central station. If the merchandise in question sells out, a different commercial can be called up immediately. If a merchandise requires explanation, a menu may be offered on the monitor, whereby special information regarding the use or assembly may be called up.

Use is advantageously also made of the information path from the remote station to the central station in such a way that the selection and duration of use of the advertising information is captured and evaluated statistically and in accounting terms. An addition to the equipment of the remote station consists of a room monitor indicator, which detects in the close proximity of the playback unit the presence of a person by means of an infrared light transmitter and receiver. Its indicator signal is evaluated statistically and by frequency analysis, based on its duration and frequency in correlation with the given image sequence, thus determining the interest of the public in certain types of merchandise and the effectiveness of the type and manner of advertisement, which allows for an optimization of the sales and advertising strategy.

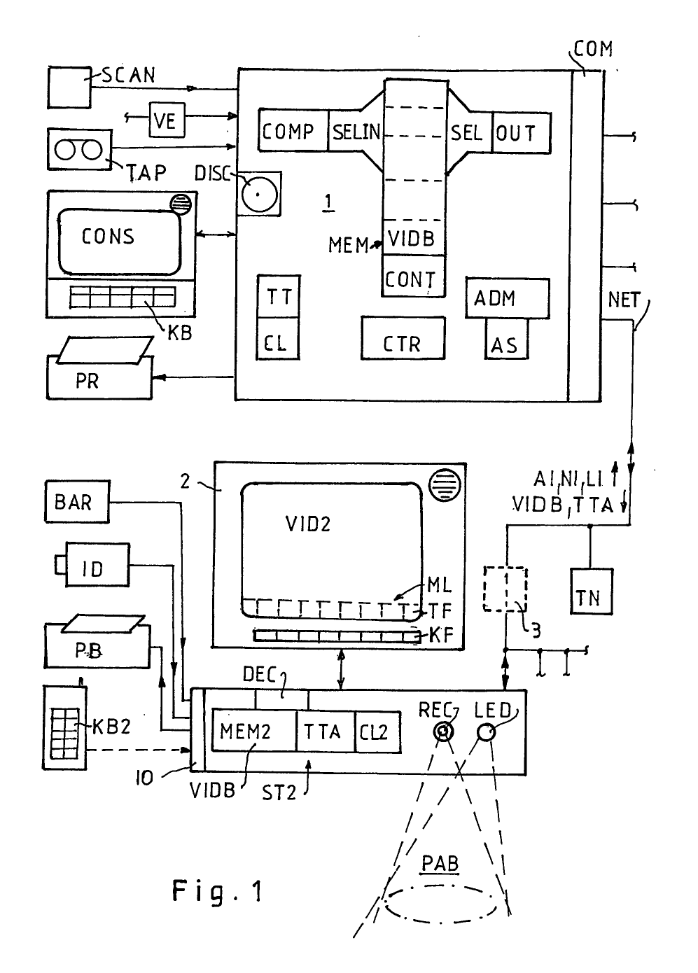

An advantageous design is presented in the circuit diagram FIG. 1.

FIG. 1 shows an overview of a circuit layout of the communication system, which consists of a central station 1 and connected thereto via a network NET, remote stations 2, of which one is shown schematically.

The central station 1 is formed by a high-performance computer, which is connected on its input side to a control console CONS and input devices SCAN, DISC, TAP, for feeding in video information and optionally to a video receiver VE, and on its output side to a communication connection means COM.

The console CONS is equipped with an operator keyboard KB, a monitor MON for image and audio playback, and a printer PR, and optionally houses the videotape player TAP and/or CD-player. The computer incorporates a relatively large memory MEM, which receives digital image and film information and keeps it available for distribution. Also contained in the memory MEM is content information CONT that serve to locate the individual video information areas VIDB of the various films, commercials, video game, etc.

The incoming video information is compressed, if this was not done previously, by means of a compressor COMP in a known manner and stored together with an entry into the index CONT in the memory MEM. Video information areas that are used only rarely are advantageously stored intermediately on an external medium, e.g., on a CD.

The stored video information areas VIDB are transmitted according to a broadcasting time schedule TT, which must be entered via the console CONS, to the remote stations 2, or selected in each case based on demand information AI coming from the remote stations, and sent there.

An internal computer clock CL serves both to process the broadcast time schedule TT, as well as to capture the duration of use of the individual video information, such as advertising films, etc. A control program CTR controls the storage and output and optionally relocation of the video information areas VIDB by means of an input address selector SEL IN and an output address selector SEL OUT, which carry out the starting addresses and the stepped addressing.

Additionally, the program contains a housekeeping program ADM, which keeps statistics regarding the use of the various video information areas VIDB in a statistics and/or accounting memory area AS, so that, possibly linked with additional commercial data, a billing can be prepared and printed out on the console CONS or at the using remote station 2.

The communication connection means COM incorporates one or more connections to a communication network NET and serves, on the various levels, the given service request for a point-to-point or dial-up connection and transforms the digital image and audio information into the respective transmission format. The networks being used may be the Internet, analog telephone lines, ISDN, DSL, satellite communications, etc.

The remote station 2 is also based on a computer as a control device ST2, which, however, requires only a smaller memory MEM2, since only a small number of image information areas currently to be played needs to be stored there. On the input side, the control device ST2 is connected to the network NET and meets the given network requests in such a way that in dial-up operation, the source and target address are also transmitted in each case and the respective dial-up, checking and security processes are performed.

On the output side, an image and audio playback unit VID2 is connected to the control device ST2. The image information that is stored intermediately in the memory MEM2 is processed via an expanding decoder DEC and formatted in the respective intended video format, such as PAL, NTSC or Secam, or read out via a digital monitor interface to the playback unit.

Depending on the given application, additional input devices are connected to the control device ST2. For example, touch area TF is provided for a program selection on the display terminal VID2, which is used in connection with a given menu bar ML that is overlayed on the image. Alternately, a row of selection keys KF is provided that is matched to the menu bar ML, or a keyboard KB2, which is connected with a cable or wirelessly serves to input data for the connection and/or program selection, as well as optionally to control additional functions.

On the input side, in particular for initiating requests that have costs associated with them, a hotel pass and/or credit card reader BAR, ID are connected. A printer PR completes the peripheral equipment of the remote station to a data terminal, in particular if a dial-up connection is present and external subscribers TN or others at the remote station 2 can also be dialed or can dial out on the dial-up network NET.

The readout information LI from the credit card or chip card is transmitted in each case for the release of a request that has costs associated with it to the central station 1 or optionally to an intermediate station 2, which may be a central hotel station, for example. The billing is entered there, and a receipt is optionally issued via the printer PR.

For application in a department store, a room monitor sensor LED, REC is advantageously connected to the control device ST2 on its input side, the infrared source LED and receiver REC of which monitor the close proximity PAB in front of the playback unit VID2, in which observers are usually located. The given length of stay and frequency of stays are evaluated and transmitted as degree-of-usage information NI to the central station 1 to the housekeeping program ADM for further evaluation.

To the extent in which the control of the selection and playback of the image information is controlled via a time schedule TT from the central station 1 and the network connection exists only for certain periods of time, e.g., in a dial-up network, a time schedule segment TTA is advantageously transmitted together with the video information segments VIDB to the control device ST2 and processed there based on a time-of-day information from a clock CL2. These given times of the clock CL2 also serve to measure the lengths of stay in the monitored viewing area FAB and the times of a selection of various information segments contained in the memory MEM2. These measured time values are transmitted to the central statistics acquisition and evaluation.

The network structure may be implemented under utilization of an in-house network, e.g., via Ethernet, Firewire, Bluetooth, etc.

The input and output devices are preferably connected via a known interface, e.g., USB port, RS232, PCMCIA. Internet access is advantageously provided at the control device ST2 as well, so that a laptop computer or the like can be connected to it, which can then utilize the dial-up function.

For department store applications in particular, the time-schedule-based control permits targeted advertisement using different advertising films at different times of the day, providing information of interest to housewives in the mornings, to students during recess, and to working people in the evenings. Company-internal messages, special offers, etc., may additionally be superimposed as well.

If a barcode reader BAR is connected to the control device ST2 in the department store or hardware store, a barcode that is read from the merchandise is used to directly select pertinent information. If a printer PR is connected as well, an appropriate information sheet is printed on demand.

An additional field of application is that of customer and/or employee training and information, wherein merchandise information is processed didactically and obtained and queried via keyboard strokes or touching of the sensor field TF.

A preferred central station set-up consists of the following:
a high-performance PC with CD-R/W (DVD and following).
a large, fast drive,
special Codec software,
for particularly fast applications, the Codec is supported by special hardware.

Additionally, the option exists to record video and audio files analog or digitally into the computer. The system comprises interface software for editing the advertising clips, comfortable distribution software to the remote stations 2, as well as the option of querying the generated data of the remote stations 2. To establish communication, the computer can determine which remote stations are online at a given time.

A preferred remote station set-up consists of the following:
main PC with hardware BIOS and main operating system,
hard drive,
video interface to connect the terminals,
data interface (ISDN, analog, Ethernet, Firewire, Bluetooth),
PCMACIA interface,
chip card reader,
power pack,
motion sensor,
clock (Internet time and standard time).

In order not to have to be online at all times, the control device has the feature of connecting online according to a defined time schedule. During this time window the central station 1 is able to establish communication and transmit data.

The communication between the central station takes place mainly over the Internet. The remote stations 2, after they have registered, are uniquely identifiable and addressable by their addresses. The Ethernet connection provides each remote station 2 with a world-wide unique station identification, which can additionally be queried and used for security.

If multiple remote stations 2 are in use in close vicinity to each other, the connection to the Internet may be created via an intermediate station 3 and communication with the other remote stations 2 may take place wirelessly, e.g., using Bluetooth. This makes wiring inexpensive and very simple.

1. A communication system comprising a central station (1) provided with a memory (MEM) and a connection means (COM) to at least one communication network (NET) for video information, in particular digitized images and films, which are transmitted over the communication network (NET) to given remote station(s) (2) connected to it and, optionally stored intermediately, and displayed on a display terminal (VID2) at this remote station in each case,
characterized in that the memory (MEM) of the central station (1) is an electronic memory (MEM), in which multiple video information blocks (VIDB) are to be stored which, in each case, are registered in an index (CONT), and transmits on demand by means of a housekeeping program (ADM) to the given communicating remote station (2) one of the selected information blocks (VIDB), and keeps a record thereof in a statistics and/or accounting memory area (AS).

2. A communication system according to claim 1, characterized in that the central station (1) is connected to an operating console (CONS) and at least one input device (TAP, DISC, SCAN) or receiver for video film and image information, through which the video information blocks (VIDB) are fed in and the given associated routing information is entered into the index (CONT).

3. A communication system according to claim 2, characterized in that the input device is a videotape reader (TAP), a CD reader and/or a scanner (SCAN).

4. A communication system according to any of the above claims, characterized in that the remote station (2) incorporates a control device (ST2) to which a dial-up device (TF, KBZ) is connected, whereby selection information (AI) is to be entered, whereby a video information block (VIDB) already contained in its memory (MEM2) or transmitted on demand in each case from the central station (1) is brought to display.

5. A communication system according to claim 4, characterized in that the selection device (TF, KB2) is a touch area (TF) on the display terminal (VID2) an/or a keyboard (KB2), which is connected via a cable or implemented as a remote control.

6. A communication system according to claim 5, characterized in that the control device (ST2), adjusted to superimpose in each case a menu bar (ML) onto a presented video information block (VIDB), contains selection information (AI) that is correlated relatable to the index (CONT).

7. A communication system according to any of the above claims, characterized in that the control device (ST2) of the remote station (2) has an input and output interface (IO), to which a barcode reader and/or chip card reader (BAR, ID) is connected, the readout information (LI) from which is transmitted to the central station (1) into the accounting memory (AS).

8. A communication system according to any of the above claims, characterized in that the input/output interface (10) of the control device (ST2) has connected to it a printer (PR) on which image information or related stored text information that is presented on demand in each case, is printed in each case.

9. A communication system according to any of the above claims, characterized in that the control device (ST2) of the remote station (2) has disposed on it a proximity switch (LED, REC), which monitors a viewing area (PAB) in front of the display terminal (VID2), and the presence-of-viewers signal is captured, relative to frequency and duration, statistically and in correlation to the respective presented video information block (VIDB) or its selection information (A1), and stored as degree-of-usage information (NI).

10. A communication system according to claim 9, characterized in that the degree-of-usage information (N I) is transmitted to the central station (1) where it is taken over into the statistics memory area (AS).

11. A communication system according to claim 10, characterized in that the degree-of-usage information (NI) is routed to a classifier, which supplies quality profiles for the form and content of the presented video information blocks (VIDB).

12. A communications system according to any of the above claims, characterized in that the video information blocks (VIDB) are compressed in the central station (1) by means of a compressor (COMP) and stored and read-out in this manner and presented at the remote stations (2) expanded in each case via a decoder (DEC).

13. A communication system according to any of the above claims, characterized in that the video information blocks (VIDB) is transformed for transmission in each case into a requested video format (PAL, NTSC, SECAM).

14. A communication system according to any of the above claims, characterized in that a transmission time schedule (TT) is entered into the central station (1), according to which time schedule the video information blocks (VIDB) are transmitted in each case to the individual remote stations (2).

15. A communication system according to claim 14, characterized in that the central station (1) co-transmits a transmission time schedule segment (TTA) in each case that is associated with the remote station (2) and the given video information block (VIDB), which is stored and processed at the remote station (2).

16. A communication system according to any of the above claims, characterized in that the communication network (NET) is at least one private and/or public hardwired and/or wireless network to which the connection means (COM) of the central unit (1) makes available in each case data transmission and signaling in conformity with the required standard.

17. A communication system according to any of the above claims, characterized in that the control device (ST2) of the remote station (2) is connected to a dial-up network, which is useable both for communication with the central station (1), as well as with other subscribers (TN), wherein the control device (ST2) that operates the input/output interface (10), the keyboard (KB2), and the interface to the network in conformity with the required standard.

18. A communication system according to claim 16, characterized in that the communication network (NET) is integrated into an intermediate station (3), which carries out partial or auxiliary functions of the housekeeping, statistics, accounting and/or time-based addressing of the central station (1) and/or a format and network interface conversion.
